(19) United States
(12) Patent Application Publication
(10) Pub. No.: US 2016/0188752 A1
(43) Pub. Date: Jun. 30, 2016

(54) DEFINING REUSABLE METRICS FOR ARCHITECTURAL OPTIMIZATION

(71) Applicant: International Business Machines Corporation, Armonk, NY (US)

(72) Inventors: Henry Broodney, Haifa (IL); Lior Limonad, Nesher (IL); Nir Mashkif, Ein Carmel (IL); Michael Masin, Haifa (IL); Aviad Sela, Yokneam (IL)

(21) Appl. No.: 14/582,217

(22) Filed: Dec. 24, 2014

(51) Int. Cl. G06F 17/50

(52) U.S. Cl. CPC G06F 17/50

(57) ABSTRACT

Methods, computing systems and computer program products implement embodiments of the present invention that include receiving, by a computer executing a system modeling application, a first input including multiple attributes and a second input including multiple components. The attribute set is associated with a plurality of the components in the system model, and based on a third input received that includes calculation parameters, one or more calculations are defined that include one or more of the attributes over the plurality of the components, thereby defining a metric for the system model.

### FIELD OF THE INVENTION

The present invention relates generally to system analysis, and specifically to defining a reusable library of set-based calculations for a system modeling application.

### BACKGROUND

System models are conceptual models that describe and represent systems such as vehicles, airplanes and computers. When defining a system, a system modeling application can be used to describe the system, and to present multiple views such as planning, requirement analysis, design, implementation, deployment, structure, behavior, input data, and output data views. One example of a system modeling application is Systems Modeling Language™ (SysML™), which implements a visual tool called a “parametric diagram” that is configured to present, on a display, mathematical relationships (such as performance constraints) among components of a system being described.

The description above is presented as a general overview of related art in this field and should not be construed as an admission that any of the information it contains constitutes prior art against the present patent application.

### SUMMARY

There is provided, in accordance with an embodiment of the present invention a method, including receiving, by a computer executing a system modeling application, a first input including multiple attributes and a second input including multiple components, storing the received attributes to an attribute set, creating a system model including the received components, associating the attribute set with a plurality of the components in the system model, receiving a third input including calculation parameters, and defining, based on the calculation parameters, one or more calculations including one or more of the attributes over the plurality of the components, thereby defining a metric for the system model.

There is also provided, in accordance with an embodiment of the present invention a computer, including a memory configured to store an attribute set and a component set, and a processor configured to receive a first input including multiple attributes and a second input including multiple components, to store the received attributes to the attribute set, to create a system model including the received components, to associate the attribute set with a plurality of the components in the system model, to receive a third input including calculation parameters, and to define, based on the calculation parameters, one or more calculations including one or more of the attributes over the plurality of the components, thereby defining a metric for the system model.

There is further provided, in accordance with an embodiment of the present invention a computer program product, the computer program product including a non-transitory computer readable storage medium having computer readable program code embodied therewith, the computer readable program code including computer readable program code configured to receive, a first input including multiple attributes and a second input including multiple components, computer readable program code configured to store the received attributes to an attribute set, computer readable program code configured to create a system model including the received components, computer readable program code configured to associate the attribute set with a plurality of the components in the system model, computer readable program code configured to receive a third input including calculation parameters, and computer readable program code configured to define, based on the calculation parameters, one or more calculations including one or more of the attributes over the plurality of the components, thereby defining a metric for the system model.

### BRIEF DESCRIPTION OF THE DRAWINGS

The disclosure is herein described, by way of example only, with reference to the accompanying drawings, wherein:

FIG. 1 is a block diagram of a computer configured to define reusable set-based calculations for a system modeling application, in accordance with an embodiment of the present invention;

FIG. 2 is a block diagram showing details of a given calculation, in accordance with an embodiment of the present invention; and

FIG. 3 is a flow diagram that schematically illustrates a method of defining the reusable set-based calculations, in accordance an embodiment of the present invention.

### DETAILED DESCRIPTION OF EMBODIMENTS

### Overview

Different architectural configurations of systems typically entail significant differences in functionality, performance, ease of manufacturing (or assembly) and operational behavior. While the functionality and performance are typically included in system optimization analyses, manufacturability metrics (e.g., production cost and time-to-market) and operational metrics (e.g., life-cycle cost and life cycle availability) are often not included. Since manufacturability metrics and/or operational metrics can be key drivers for determining total lifecycle cost, neglecting them can significantly impact a given system's operating costs.

Embodiments of the present invention provide methods and systems for including manufacturability and operational metrics in system analysis by defining reusable operational metrics that are based on operational life cycle processes (e.g., manufacturing, “sunny day” operation, and unplanned maintenance), and connecting the metrics with historical data for computation, thereby enhancing system optimization capabilities of a system modeling application.

As explained hereinbelow, based on inputs received from a user, a system modeling application can create a set of attributes comprising metrics to be analyzed, create a system model comprising multiple components such as blocks and parts in a system model such as a parametric diagram in SysML™, and then assign the set of the attributes to a subset of the components. The system modeling application can then define one or more calculations, wherein each calculation comprises one more attributes over the subset of the components, and store the one or more calculations to a reusable library.

When analyzing a given system, the calculations define metrics for the given system such as manufacturability metrics, operational metrics for the given system, functionality, performance, availability, total life cycle cost and affordability. Therefore, while performing a system analysis, the system modeling application can incorporate a given equation into the system model, thereby enabling a user to analyze and optimize the system model.

### System Description

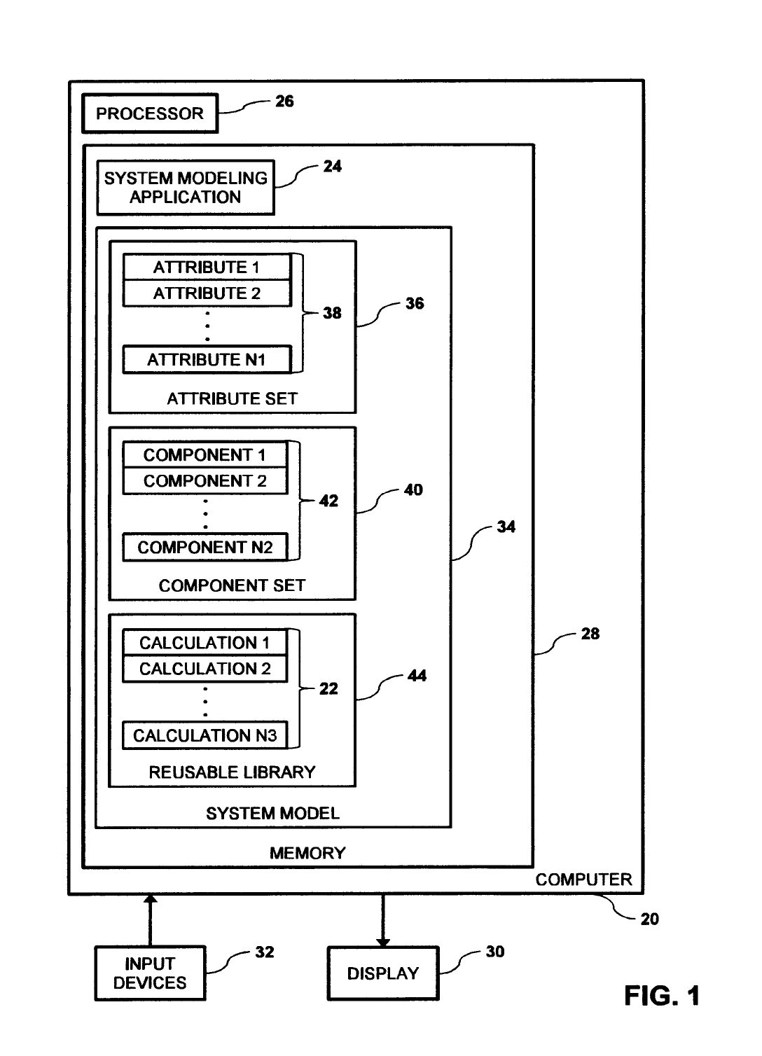

FIG. 1 is a block diagram of a computer 20 configured to define reusable set-based calculations 22 for a system modeling application 24 that a processor 26 executes from a memory 28, in accordance with an embodiment of the present invention. Examples of system modeling application 24 include, but are not limited to software applications such as SysML™ and Modelica™.

In addition to processor 26 and memory 28, computer 20 comprises a display 30, and one or more input devices 32 such as a keyboard and a mouse. Based on inputs received from a user (not shown) via input devices 32, system modeling application 24 creates and maintains system model 34 in memory 28. In embodiments where system modeling application comprises SysML™, system model 34 may comprise a parametric diagram.

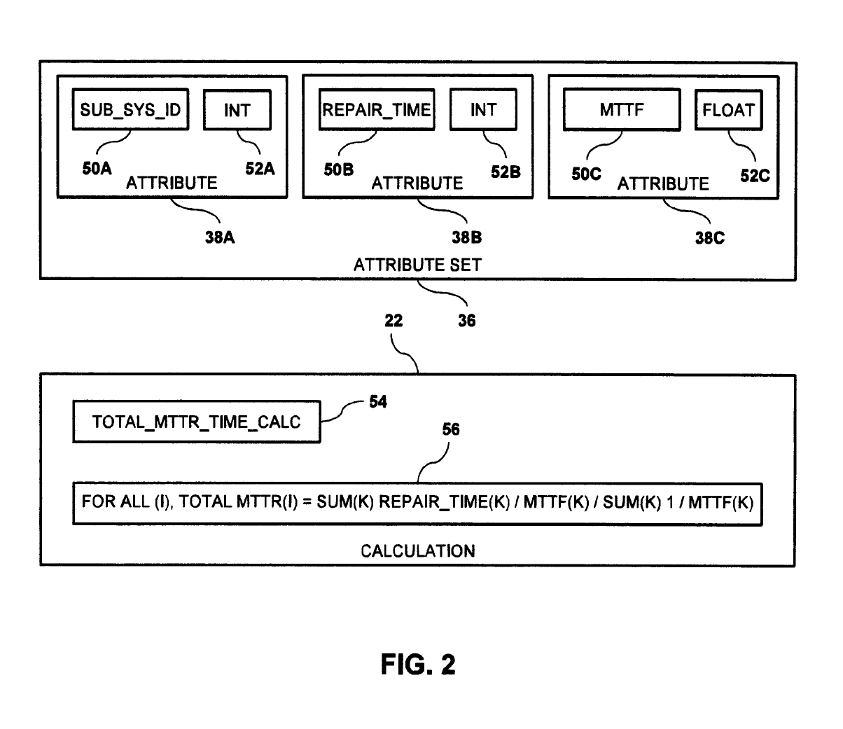

System model 34 comprises an attribute set 36 comprising multiple attributes 38, a component set 40 comprising multiple components 42, and a reusable library 44 comprising multiple calculations 22. In embodiments of the present invention, calculations 22 are reusable in the sense that a given calculation 22 is not dedicated to a given component 42. In other words, a given calculation 22 can be used by multiple components 42. Attributes 38 and calculations 22 are described hereinbelow with reference to FIG. 2.

Components 42 comprise “building blocks” that system modeling application 24 can use to create and maintain system model 34. In embodiments where system model 34 comprises a SysML™ parametric diagram, components 42 comprise blocks, parts and stereotypes (i.e., scopes). For example, if system model 34 defines a computing site comprising multiple network servers, the blocks may comprise the computer servers, and the parts may comprise individual hardware units of the servers such as processors, storage devices, memory modules, and communication interfaces.

Processor 26 typically comprises a general-purpose computer, which is programmed in software to carry out the functions described herein. The software may be downloaded to computer 20 in electronic form, over a network, for example, or it may be provided on non-transitory tangible media, such as optical, magnetic or electronic memory media. Alternatively, some or all of the functions of processor 26 may be carried out by dedicated or programmable digital hardware components, or using a combination of hardware and software elements.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Defining Reusable Calculations

FIG. 2 is a block diagram showing an example of attribute set 36 and a given calculation 22, in accordance with an embodiment of the present invention. Each attribute 38 comprises an attribute identifier 50 and an attribute type 52, and each calculation 22 comprises a calculation identifier 54 and an equation 56.

In the configuration shown in FIG. 2, attributes 38 and their respective attribute identifiers 50 and attribute types 52 can be differentiated by appending a letter to the identifying numeral, so that the attributes comprise attributes 38A-38C. Attribute 38A comprises attribute identifier 50A and attribute type 52A, attribute 38B comprises attribute identifier 50B and attribute type 52B, and attribute 38C comprises attribute identifier 50C and attribute type 52C. In the example shown in FIG. 2, attribute name 50A stores “SUB_SYS_ID” (i.e., a part identifier) and attribute type 52A store “INT” (i.e., integer type), attribute name 50B stores “REPAIR_TIME” (i.e., an estimated time needed to repair the part) and attribute type 52B store “INT”, and attribute name 50C stores “MTTF” (i.e., the part's mean time to failure) and attribute type 52C store “FLOAT” (i.e., floating point type).

In some embodiments, each component 42 is associated with a separate instance of attribute set 36. In the example where system model 34 describes a computing site comprising components 42, the components comprise blocks that reference multiple networked servers, and parts that reference hardware units such as processors, memory modules, storage devices, and communication adapters.

For example, the computing site may comprise “I” networked servers, and each of the servers has “K” hardware units. Therefore, equation 56 in calculation 22 whose calculation identifier 54 stores “TOTAL_MTTR_TIME_CALC” can be used to calculate mean time to repair for the computing site as follows:

FOR ALL (I),

TOTAL MTTR(I)=SUM (K) REPAIR TIME (K)/MTTF(K)/SUM (K) 1/MTTF(K)

In embodiments of the present invention, each equation 56 can be “set-based”, and may not be tied to a specific I or K.

Therefore, when analyzing the computing site in system model 34, a user can change the number of servers (i.e., I) or change the number of storage devices in each server (i.e., K) and system modeling application 24 can use equation 56 to recalculate the given calculation without any changes to the equation. In other words, embodiments of the present invention can provide a classification by property extension to system modeling applications such as SysML™.

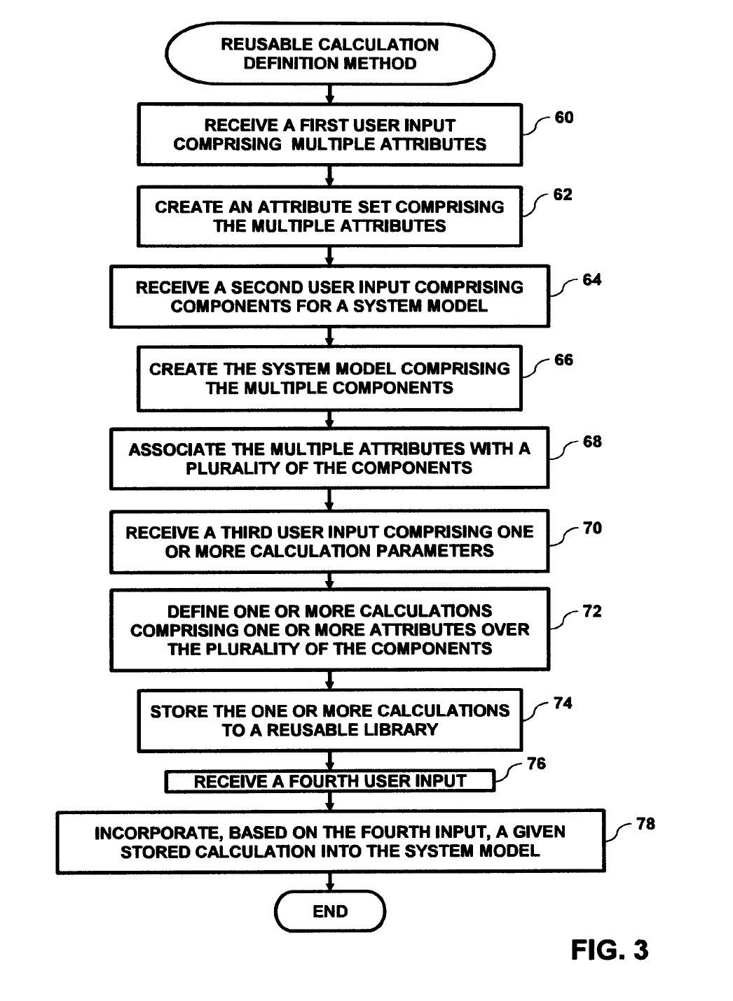

FIG. 3 is a flow diagram that schematically illustrates a method of defining a given calculation 22, in accordance an embodiment of the present invention. In embodiments of the present invention, the steps described in the flow diagram are performed by modeling application 24 comprising a software application such as SysML™ that is executing on processor 26.

In a first receive step 60, processor 26 receives, from a user via input devices 32, a first input comprising multiple attributes 38, and in a first creation step 62, the processor uses the received attributes to create attribute set 36. In a second receive step 64, processor 26 receives, from the user via input devices 32, a second input comprising components 42, and in a second creation step 66, the processor creates system model 34 using the received components to create component set 40. As described supra, in a SysML™ model, the received components may comprise blocks, parts and stereotypes, and system model 34 may comprise a parametric diagram.

In an assignment step 68, processor 26 associates the multiple attributes to a plurality of components 42 (i.e., a subset of component set 40). In other words, when creating the parametric diagram, processor 26 can assign attributes 38 to a given component 42. In the example described hereinabove with reference to FIG. 2, processor 26 can assign, in the parametric diagram, attributes 38A, 38B and 38C to each hardware unit in the computing site.

In some embodiments, each component 42 may have respective component attributes, and processor 26 can associate the multiple attributes with multiple components 42 by identifying one or more component attributes, and associating the multiple attributes with all components 42 having the identified one or more attributes. In additional embodiments, a given metric of one or more given attribute set 36 can be associated with a given component 42 multiple times. For example, a resource allocation metric can be applied to a given component 42 to allocate memory, bandwidth or central processing unit (CPU) power.

In a third receive step 70, processor 26 receives a third input comprising one or more calculation parameters, and in a definition step 72, the processor defines, based on the received calculation parameters, one or more equations 56, and stores each of the equations to a respective calculation 22. In embodiments of the present invention each calculation 22 comprises a given equation 56 comprising one or more attributes 38 over the plurality of components assigned to the attributes in step 68.

In a store step 74, processor 26 stores the one or more defined calculations 22 to reusable library 44. In a fourth input step 76, processor 26 receives a fourth input from the user, and based on the fourth input, the processor incorporates a given calculation 22 into system model 34 in an incorporation step 78, and the method ends. In the example described hereinabove with reference to FIG. 2, processor 26 can incorporate a given calculation 22 in system model 34 in order to ascertain a mean time to repair parameter for all of the hardware units in the computing site.

The flowchart(s) and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
receiving, by a computer executing a system modeling application, a first input comprising multiple attributes and a second input comprising multiple components;
storing the received attributes to an attribute set;
creating a system model comprising the received components;
associating the attribute set with a plurality of the components in the system model;
receiving a third input comprising calculation parameters; and
defining, based on the calculation parameters, one or more calculations comprising one or more of the attributes over the plurality of the components, thereby defining a metric for the system model.

2. The method according to claim 1, wherein the system model comprises a parametric diagram in a system modeling language (SysML) model.

3. The method according to claim 2, wherein each of the components is selected from a list consisting of a block and a part.

4. The method according to claim 1, wherein the metric is selected from a list consisting of a manufacturability metric, an operational metric, functionality, performance, availability, total life cycle cost and affordability.

5. The method according to claim 4, and comprising defining a reusable library comprising the one or more calculations.

6. The method according to claim 5, and comprising receiving a fourth input and incorporating, based on the fourth input, a given calculation from the reusable library into the system model.

7. A computer, comprising:
a memory configured to store an attribute set and a component set; and
a processor configured:
to receive a first input comprising multiple attributes and a second input comprising multiple components;
to store the received attributes to the attribute set;
to create a system model comprising the received components;
to associate the attribute set with a plurality of the components in the system model;
to receive a third input comprising calculation parameters; and
to define, based on the calculation parameters, one or more calculations comprising one or more of the attributes over the plurality of the components, thereby defining a metric for the system model.

8. The computer according to claim 7, wherein the system model comprises a parametric diagram in a system modeling language (SysML) model.

9. The computer according to claim 8, wherein each of the components is selected from a list consisting of a block and a part.

10. The computer according to claim 7, wherein the metric is selected from a list consisting of a manufacturability metric, an operational metric, functionality, performance, availability, total life cycle cost and affordability.

11. The computer according to claim 10, wherein the processor is configured to define a reusable library comprising the one or more calculations.

12. The computer according to claim 11, wherein the processor is configured to receive a fourth input and to incorporate, based on the fourth input, a given calculation from the reusable library into the system model.

13. A computer program product, the computer program product comprising:
a non-transitory computer readable storage medium having computer readable program code embodied therewith, the computer readable program code comprising:
computer readable program code configured to receive, a first input comprising multiple attributes and a second input comprising multiple components;
computer readable program code configured to store the received attributes to an attribute set;
computer readable program code configured to create a system model comprising the received components;
computer readable program code configured to associate the attribute set with a plurality of the components in the system model;
computer readable program code configured to receive a third input comprising calculation parameters; and
computer readable program code configured to define, based on the calculation parameters, one or more calculations comprising one or more of the attributes over the plurality of the components, thereby defining a metric for the system model.

14. The computer program product according to claim 13, wherein the system model comprises a parametric diagram in a system modeling language (SysML) model.

15. The computer program product according to claim 14, wherein each of the components is selected from a list consisting of a block and a part.

16. The computer program product according to claim 15, wherein the metric is selected from a list consisting of a manufacturability metric, an operational metric, functionality, performance, availability, total life cycle cost and affordability.

17. The computer program product according to claim 16, and comprising computer readable program code configured to define a reusable library comprising the one or more calculations.

18. The computer program product according to claim 17, and comprising computer readable program code configured to receive a fourth input and to incorporate, based on the fourth input, a given calculation from the reusable library into the system model.
